(19) United States
(12) Patent Application Publication
(10) Pub. No.: US 2006/0090441 A1
(43) Pub. Date: May 4, 2006

(54) Lawn mower/lawn edger for use with an electric scooter

(76) Inventor: Chien Liang Chiu, Hsinchu City (TW)

Correspondence Address: MORTON J. ROSENBERG, ESQ.;ROSENBERG, KLEIN & LEE, 3458 ELLIOTT CENTER DRIVE, SUITE 101, ELLICOTT CITY, MD, 21043, US

(21) Appl. No.: 10/980,229

(22) Filed: Nov. 4, 2004

(51) Int. Cl. A01D 34/03

(52) U.S. Cl. 56/14.7

(57) ABSTRACT

A lawn mower includes a base frame with a rear U-shaped wheel bracket, two motors mounted on a respective motor holder at the U-shaped bracket at the top, a bottom-open hollow shell fastened to the base frame and the U-shaped wheel brackets at the bottom, two cutter blades respectively fastened to the output shafts of the motors inside the bottom-open hollow shell for mowing a lawn upon operation of the motors, wheel assemblies mounted in the base frame and the rear U-shaped wheel bracket for moving, and a coupling frame for connecting the base frame to an electric scooter for enabling the lawn mower to be moved on a lawn by the electric scooter.

### BACKGROUND OF THE INVENTION

1. Field of the Invention

The present invention relates to a lawn mower/lawn edger and more particularly, to a lawn mower/lawn edger for use with an electric vehicle.

2. Description of the Related Art

Various lawn mowing and trimming apparatus including hand mowers, power mowers, and riding mowers are known. When moving a hand mower with the hand on a lawn, the cutting mechanism is forced to move and to cut the lawn. Operating a hand mower requires much effort. A power mower uses a motor to drive the cutting mechanism. When using a power mower, the user needs also to move the power mower on the lawn by hand. For mowing a big area of lawn, a riding mower may be used. However, a riding mower is heavy and expensive, and requires much storage space. Further, an aged person may use an electric scooter as one's personal transportable vehicle. It is practical to couple a hand mower to an electric scooter so that the user can ride the electric scooter to move the hand mower to mow a lawn.

### SUMMARY OF THE INVENTION

4. The present invention has been accomplished under the circumstances in view. It is one object of the present invention to provide a lawn mower/lawn edger, which is connectable to an electric scooter so that the user can ride the electric scooter to move the lawn mower to mow a lawn. It is another object of the present invention to provide a lawn mower/lawn edger, which allows the user to adjust the cutting elevation. According to one aspect of the present invention, the lawn mower/lawn edger comprises a base frame equipped with wheel assemblies, two motors installed in the base frame, a shell fastened to the motors, and two cutter blades respectively fastened to the output shafts of the motors below the shell for mowing a lawn upon operation of the motors, and a coupling frame for connecting the base frame to an electric scooter for enabling the lawn mower to be moved on a lawn by the electric scooter. According to another aspect of the present invention, each wheel assembly comprises a mounting screw rod, and an adjustment nut threaded onto the mounting screw rod and rotatable to adjust the elevation of the respective wheel assembly relative to the lawn mower.

### BRIEF DESCRIPTION OF THE DRAWINGS

FIG. 1 is an exploded view of a lawn mower according to the present invention.

FIG. 2 is an exploded view showing the connection arrangement between the lawn mower and an electric scooter according to the present invention.

FIG. 3 is an assembly view of FIG. 2.

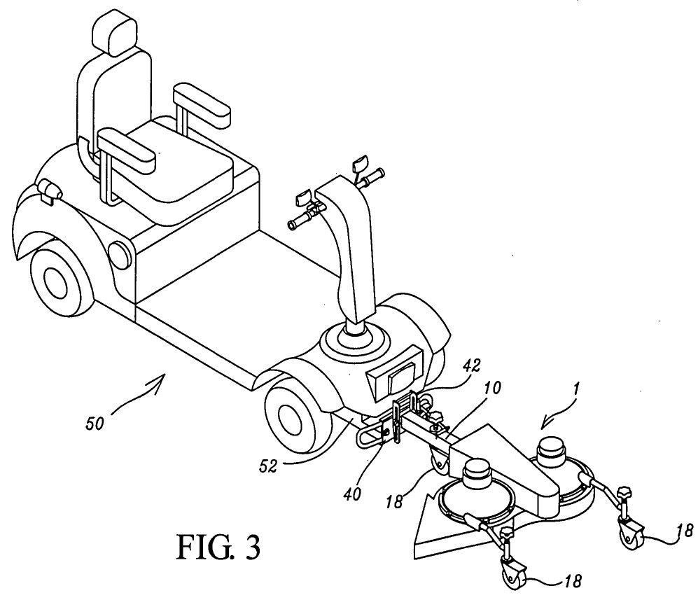

FIG. 4 illustrates the lawn mower locked to the electric scooter in the non-operative position according to the present invention.

FIG. 5 is an exploded view of a lawn edger according to the present invention.

FIG. 6 is a schematic drawing showing the lawn edger connected to an electric scooter according to the present invention.

### DETAILED DESCRIPTION OF THE PREFERRED EMBODIMENT

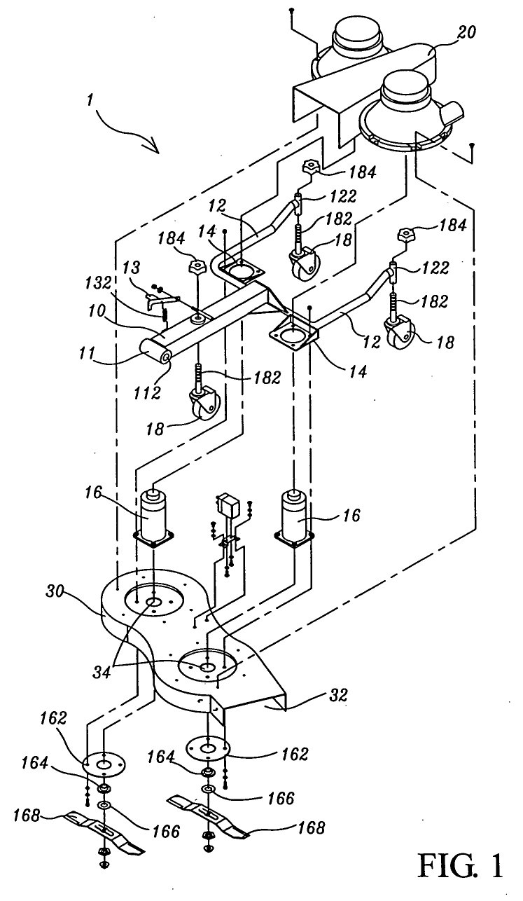

Referring to FIG. 1, a lawn mower 1 is shown comprising an elongated base frame 10, a substantially U-shaped wheel bracket 12 provided at the rear side of the base frame 10, two motor holders 14 fixedly provided at the U-shaped wheel bracket 12 at two sides relative to the base frame 10, a hollow shell 30, which is provided at the bottom side of the base frame 10 and the U-shaped wheel bracket 12 and has a side opening 32 and two vertical through holes 34, two motors 16 respectively mounted in the motor holders 14 and having the respective output shaft respectively downwardly extended through the vertical through holes 34 of the hollow shell 30, a top cover 20 covered on the base frame 10 and the U-shaped wheel bracket 12 over the motor mounts 14 to protect the motors 16, two washers 162 respectively mounted on the output shafts of the motors 16 and fastened to the bottom wall of the hollow shell 30, two bushings 164 respectively mounted on the output shafts of the motors 16 and attached to the washers 162 at the bottom side, two cutter blades 168 respectively affixed to the output shafts of the motors 16 by spring washers 166, and three wheel assemblies 18 respectively fastened to the base frame 10 and the two distal ends of the U-shaped wheel bracket 12. The U-shaped wheel bracket 12 has a barrel 122 fixedly vertically provided at each of the two distal ends. The wheel assemblies 18 each have a top screw rod 182 respectively vertically inserted through the base frame 10 and the barrels 122 at the ends of the U-shaped wheel bracket 12 and then screwed up with a respective adjustment nut 184. By means of rotating the adjustment nut 184 clockwise or counter-clockwise, the elevation of the wheel assemblies 18 above the lawn is relatively adjusted.

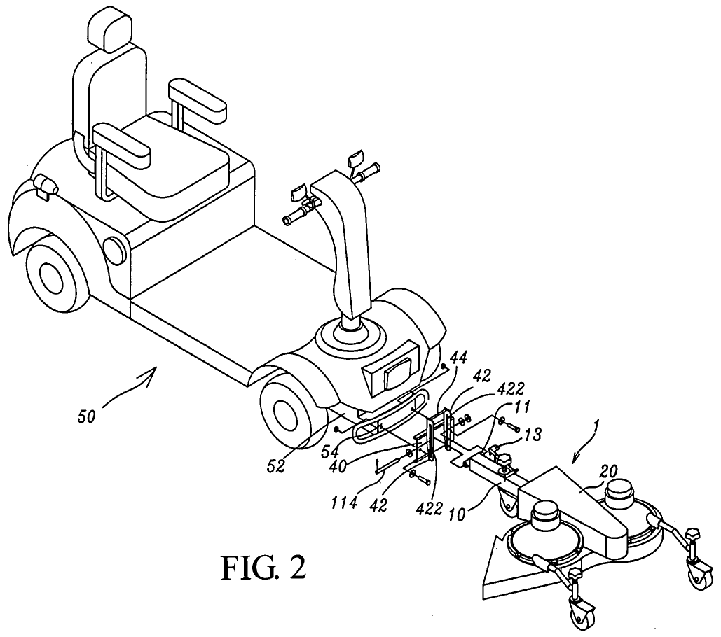

Referring to FIG. 2 and FIG. 1 again, the base frame 10 has a barrel 11 transversely provided at the front side and connected to the chassis 52 of a motor vehicle, for example, an electric scooter 50 by a connecting frame 40. The connecting frame 40 is fixedly fastened to the front side 54 of the chassis 52 of the electric scooter 50, having two vertical rails 42 arranged in parallel at the front side and a transverse bar 44 connected between the vertical rails 42 at the top. Each vertical rail 42 defines a vertical sliding slot 422 below the elevation of the transverse bar 44. The pitch between the vertical rails 42 is not less than the length of the barrel 11 so that the barrel 11 can be set horizontally between the vertical rails 42 below the transverse bar 44. A pivot pin 114 is inserted through the vertical sliding slots 422 of the vertical rails 42 and the axially extended center through hole 111 of the barrel 11 to secure the base frame 10 to the connecting frame 40. Because the law mower 1 is coupled to the front side of the electric scooter 50, the law mower 1 is moved with the electric scooter 50 when the user rides the electric scooter 50. Therefore, the user can move the lawn mower 1 to mow a lawn efficiently with less labor.

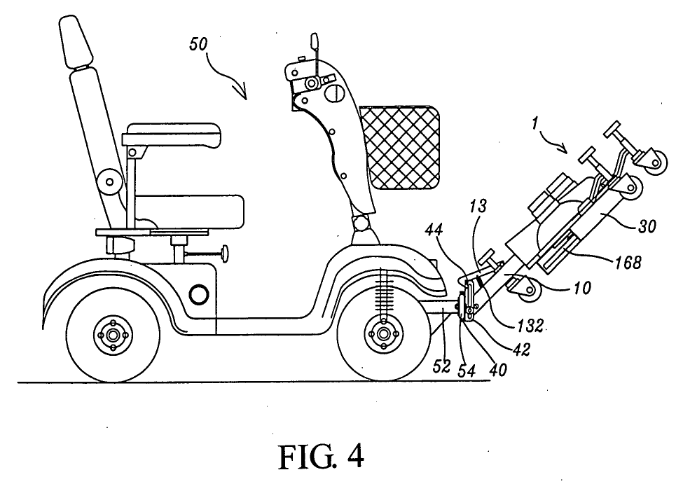

Referring to FIG. 4 and FIG. 1 again, a hook 13 is pivotally provided at one lateral side of the base frame 10, and a tensile spring 132 is connected between the hook 13 and the base frame 10 to hold the hook 13 closely attached to one lateral side of the base frame 10. When wishing to ride the electric scooter 50 without mowing a lawn, the user can lift the mower 1 from the ground and then hook the hook 13 on the transverse bar 44 of the connecting frame 40, keeping the mower 1 in the non-operative position.

As indicated above, by means of the base frame 10 and the connecting frame 40, the mower 1 can be connected to any of a variety of vehicles, for enabling the vehicle to move the mower 1 to mow a lawn efficiently with less effort. Further, by means of rotating the adjustment nuts 184, the user can easily adjust the cutting height of the law mower 1.

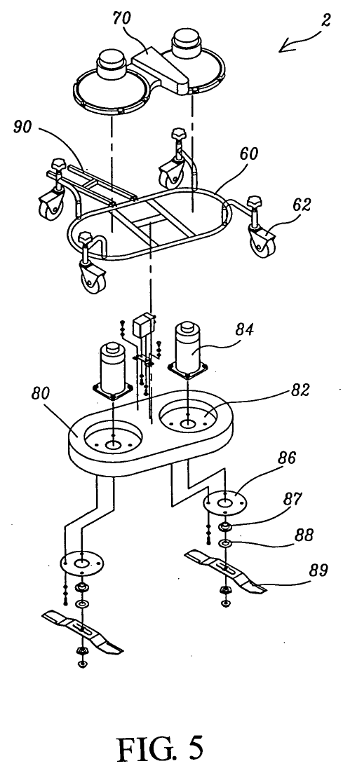

FIG. 5 is an exploded view of a lawn edger 2. As illustrated, the lawn edger 3 comprises an oval open base frame 60, a plurality of wheel assemblies 62 symmetrically connected to the oval open base frame 60, a shell 80 fixedly fastened to the bottom side of the oval open base frame 60, two motors 84 respectively vertically fastened to a respective seat 82 in the shell 80 with the respective output shaft extending to the bottom side of the shell 80, washers 86 and bushings 87 respectively mounted on the output shafts of the motors 84, two cutter blades 89 respectively affixed to the output shafts of the motors 84, spring washers 88 respectively fastened to the output shafts of the motors 84 and stopped at two sides of each of the cutter blades 89, and a top cover 70 fastened to the top side of the oval open base frame 60 and covered over the motors 84 for protection.

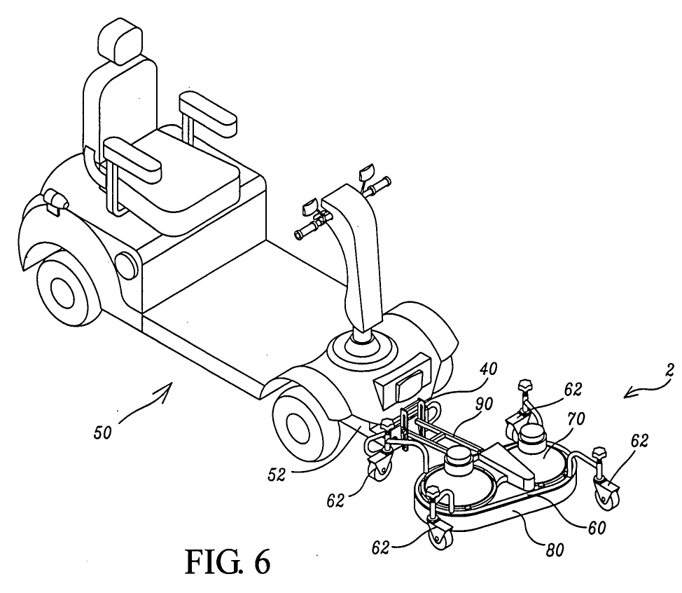

Referring to FIG. 6, a wheeled coupling frame 90 connects the lawn edger 2 to the front side of an electric scooter 50 so that the user can ride the electric scooter 50 to move the lawn edger 2 over a lawn and to edge the lawn efficiently with less effort.

A prototype of lawn mower/lawn edger for use with an electric vehicle has been constructed with the features of FIGS. 1˜6. The lawn mower/lawn edger for use with an electric vehicle functions smoothly to provide all of the features discussed earlier.

Although a particular embodiment of the invention has been described in detail for purposes of illustration, various modifications and enhancements may be made without departing from the spirit and scope of the invention.

What the invention claimed is:

1. A lawn mower comprising:
an elongated base frame, said base frame having a substantially U-shaped wheel bracket at a rear side thereof and a transverse barrel at a front side thereof;
two motor holders fixedly mounted on said U-shaped bracket at side;
two motors respectively mounted in said motor holders, said motors each having an output shaft vertically downwardly suspended below said motor holders and said U-shaped wheel bracket;
a bottom-open hollow shell fastened to said base frame and said U-shaped wheel brackets at a bottom side;
two cutter blades respectively fastened to the output shafts of said motors inside said bottom-open hollow shell for mowing a lawn upon operation of said motors;
a plurality of wheel assemblies for enabling the lawn mower to be moved on a lawn; and
coupling means for coupling said base frame to an electric scooter.

2. The lawn mower as claimed in claim 1, further comprising a plurality of washers and bushings respectively mounted on the output shafts of said motor for supporting the output shafts of said motors on said hollow shell.

3. The lawn mower as claimed in claim 1, further comprises a plurality of spring washers respectively fastened to the output shafts of said motors at two sides of each of said cutter blades.

4. The lawn mower as claimed in claim 1, wherein said coupling means comprise a connecting frame fixedly fastened to the front side of the chassis of an electric scooter, said connecting frame having two vertical rails arranged in parallel at a front side thereof and a transverse bar connected between said vertical rails at a top side, said vertical rails each defining a vertical sliding slot, and a pivot pin inserted through the vertical sliding slots of said vertical rails and the transverse barrel of said base frame to connect said base frame to said connecting frame.

5. The law mower as claimed in claim 4, further comprising a hook pivoted to said base frame for hooking on the transverse bar of said connecting frame to hold said lawn mower in a tilted non-operative position above the elevation of the chassis of said electric scooter.

6. The lawn mower as claimed in claim 5, further comprising a tensile spring connected between said base frame and said hook to hold said hook in a received position.

7. The lawn mower as claimed in claim 1, wherein said wheel assemblies are respectively installed in said base frame at a front side and said U-shaped wheel bracket at two opposite lateral sides.

8. The lawn mower as claimed in claim 7, wherein said wheel assemblies each comprise a mounting screw rod and an adjustment nut threaded onto said mounting screw rod and rotatable to adjust the elevation of the respective wheel assembly relative to the lawn mower.

9. The lawn mower as claimed in claim 1, wherein said bottom-open hollow shell has a side opening.

10. The lawn mower as claimed in claim 1, further comprising a top cover covered on a top side of said base frame and said U-shaped wheel bracket over said motors.

11. A lawn edger comprising:
an oval open base frame equipped with wheel assemblies for moving;
a shell fixedly fastened to said oval open base frame at a bottom side, said shell having two seats;
two motors respectively vertically fastened to the seats of said shell, said motors each having an output shaft suspended below said shell; and
two cutter blades respectively fixedly mounted on the output shafts of said motors below said shell.

12. The lawn edger as claimed in claim 11, further comprising a top cover covered on said shell over said motors.

13. The lawn edger as claimed in claim 11, further comprising washers and bushings respectively mounted on the output shafts of said motors.

14. The lawn edger as claimed in claim 11, further comprising a plurality of spring washers respectively fastened to the output shafts of said motors at two sides of each of said cutter blades.

15. The lawn edger as claimed in claim 11, further comprising a wheeled coupling frame for connecting said oval open base frame to the front side of the chassis of an electric scooter.
